(19) United States
(12) Patent Application Publication
(10) Pub. No.: US 2026/0279034 A1
(43) Pub. Date: Sep. 17, 2026

(54) PARTIAL CONVOLUTION WITH VISUAL ATTENTION

(71) Applicants: XILINX INC., SAN JOSE, CA (US); Xilinx Technology Beijing Limited, Beijing (CN)

(72) Inventors: Fuwei Yang, Beijing (CN); HaiDuo Huang, Shaanxi Province (CN); Ji Liu, Beijing (CN); Lu Tian, Beijing (CN); Emad Barsoum, Sammamish, WA (US); Jinzhang Peng, Beijing (CN); Dong Li, Beijing (CN)

(21) Appl. No.: 19/078,419

(22) Filed: Mar. 13, 2025

(51) Int. Cl. G06V 10/82; G06V 10/56; G06V 10/764; G06V 10/77; G06V 10/94

(52) U.S. Cl. CPC G06V 10/82; G06V 10/764; G06V 10/7715; G06V 10/94; G06V 10/56

(57) ABSTRACT

An apparatus includes a processing unit implemented with one or more processor cores configured to access a feature map comprising a plurality of channels of numerical values representing encoded data. The processing is also configured to generate first data and second data. The first data is generated by applying partial convolution to a first subset of the plurality of channels and the second data is generated by applying a visual attention transformer to a second subset of the plurality of channels. The second subset is different than the first subset. The first data and the second data are then combined to form information representing at least one feature in the feature map. In some cases, the apparatus is included in a neural network system configured to perform feature classification on images.

### BACKGROUND

Machine learning (ML) models, which include artificial intelligence (AI) models and techniques, often operate on numerical representations of data such as text, audio, and images. A typical numerical representation is an embedding such as a vector embedding that encodes features of the data in a series (or vector) of numerical values. An ML model is trained to transform the numerical representation of the input data into one or more output values such as a value indicating the identity of a feature in the data, a classification of the feature, or a value that is predicted based upon the input data. Training approaches include supervised learning, unsupervised learning, and reinforcement learning. For example, computer vision systems are implemented by training ML models to derive meaningful information from digital images, videos, or other visual inputs. Examples of computer vision tasks include image classification, object detection, object tracking, and content-based image retrieval.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that applies partial convolution with visual attention to a feature map such as a tensor of image pixels, according to some embodiments.

FIG. 2 illustrates applying convolution to a set of input channels to generate a corresponding set of output channels.

FIG. 3 illustrates applying depthwise convolution to a set of input channels to generate a corresponding set of output channels.

FIG. 4 illustrates applying partial convolution to a set of input channels to generate a corresponding set of output channels.

FIG. 5 illustrates applying partial convolution with attention to a set of input channels to generate a corresponding set of output channels, according to some embodiments.

FIG. 6 illustrates a neural network system that performs partial convolution on a first subset of channels and visual attention to a second subset of the channels, according to some embodiments.

FIG. 7 illustrates a partial visual attention (PAT) block that implements channel attention, according to some embodiments.

FIG. 8 illustrates a PAT block that implements spatial attention, according to some embodiments.

FIG. 9 illustrates a PAT block that implements self-attention, according to some embodiments.

FIG. 10 illustrates a PAT block that implements fused spatial attention, according to some embodiments.

### DETAILED DESCRIPTION

A machine learning (ML) model for a computer vision application can be implemented using a convolutional neural network (CNN), which is a feed-forward neural network that is trained to identify features based on filters or kernels that are convolved with portions of the image to produce output values, vectors, or tensors. A conventional CNN convolves one or more kernels over the feature map that represents the image. The feature map is typically a tensor having height, width, and channel dimensions. For example, the feature map for an image can be represented as values of pixels (indicated by height and width values) in a set of channels such as the red, green, and blue channels of a color image. Additional channel dimensions can also be present in the feature map. Conventional CNN models are relatively inefficient because they require many floating-point operations and model parameters. Depthwise separable convolution improves model efficiency (relative to conventional CNN) by mapping subsets of the filters or kernels to corresponding subsets of channels. For example, a first filter can be mapped to the red channel of the color image, a second filter can be mapped to the green channel, and a third filter can be mapped to the blue channel. Although depthwise separable convolution can improve the inference speed in some cases, these techniques require frequent memory access and support low degrees of parallelism. One alternative to depthwise separable convolution is partial convolution, which leverages the redundancy that can exist between channels in the feature map by selectively applying the filters or kernels to a subset of the input channels and leaving the remaining channels untouched, i.e., applying an identity mapping to the remaining channels. Partial convolution requires fewer floating-point operations than conventional convolution and more floating-point operations than depthwise separable convolution. However, partial convolution does not utilize information in the untouched channels, as well as being constrained by local dependencies inherent to CNNs, which can reduce accuracy.

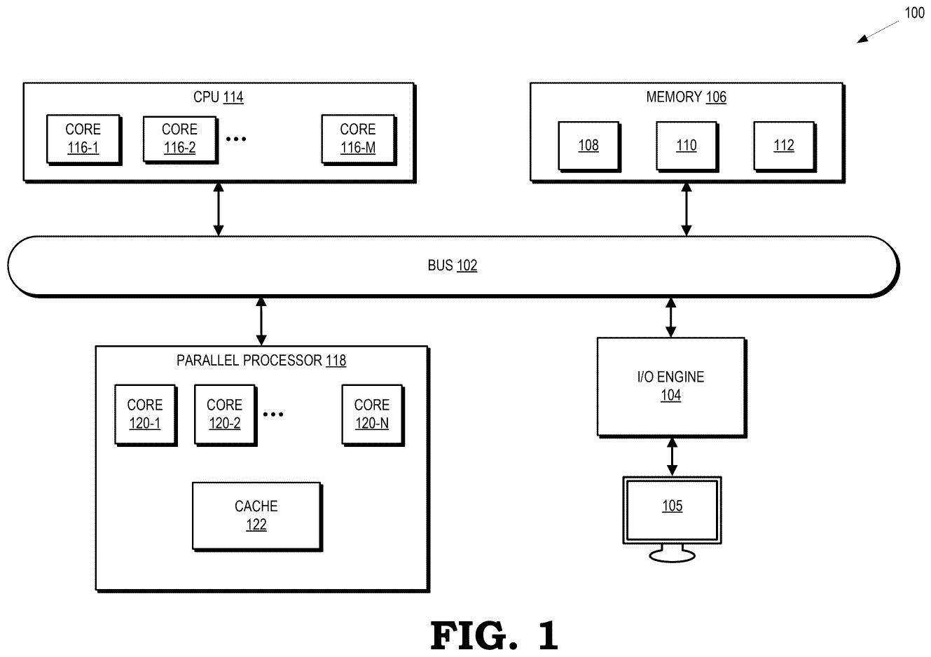

FIGS. 1-10 illustrate systems, methods, and apparatuses that increase the accuracy of a partial convolution model, while maintaining or having limited influence on inference speed, by applying partial convolution to a first subset of channels of a feature map and applying a visual attention transformer to a second subset (different than the first subset) of channels of the feature map. The visual attention block can implement channel attention, spatial attention, self-attention, or a combination thereof. In some embodiments, channel attention is implemented in conjunction with a convolution operation such as a 3×3 convolution kernel that is applied to the first subset of channels. A dense convolution and a Hard-Sigmoid function can be used to obtain attention weights for the second subset of channels. In some embodiments, spatial attention is implemented in conjunction with a convolution operation such as a 1×1 convolution kernel that is applied to the first subset. The spatial attention mechanism applies a point-wise convolution to the second subset to convert global channel information into a spatial tensor having a single channel. The spatial tensor represents a spatial attention map that is used to weight features in the second subset. In some embodiments, self-attention is implemented by applying convolution operations to the second subset to compute tensors representing query, key, and value associated with the input features. For example, 1×1 convolution kernels can be applied to determine the query, key, and value tensors associated with the second subset of channels. The input feature map provided to each partial convolution block is split into tensors representing the first subset and the second subset. Convolution operators are applied to the first subset along a first branch of the partial convolution block and visual attention is applied to the second subset along a second branch of the partial convolution block. Tensors generated by the first and second branches are then concatenated to form an output tensor. A neural network system is implemented using combinations of blocks that combine partial convolution and visual attention, as well as embedding blocks, merging blocks, pooling layers or blocks, and the like.

FIG. 1 is a block diagram of a processing system 100 that applies partial convolution with visual attention to a feature map such as a tensor of image pixels, according to some embodiments. The processing system 100 includes a bus 102 implemented with circuitry that supports communication between entities implemented in the processing system 100. As used herein, the term “circuit” can include a processing unit, or portion thereof, and corresponding software instructions that when executed by the processing unit or portion thereof, implement the corresponding function(s) ascribed to the circuit. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component implemented using a non-transitory computer-readable medium such as a dynamic random-access memory (DRAM). However, some embodiments of the memory 106 are implemented using other types of memory including, for example, static random-access memory (SRAM), nonvolatile RAM, and the like. Some embodiments of the memory 106 include an external memory implemented external to the processing units implemented in the processing system 100. The memory 106 can store information representing instructions such as program code 108 for one or more applications (e.g., graphics applications, compute applications, machine learning applications), data 110 that is consumed by the program code 108, and results 112 produced by executing the program code 108.

The processing system 100 includes a central processing unit (CPU) 114 that is connected to the bus 102 to communicate with other entities in the processing system 100, such as the I/O engine 104, the memory 106, or other entities connected to the bus 102. The CPU 114 is implemented with circuitry including a plurality of processor cores 116-1, 116-2, . . . 116-M that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 106. The CPU 114 can consume data 110 and store information in the memory 106 such as the results 112 of the executed instructions.

The processing system 100 also includes a parallel processor 118. The parallel processor 118 can include, for example, a GPU, a general-purpose GPU (GPGPU), a neural processing unit (NPU), an intelligence processing unit (IPU) or other vector processor or type of parallel processor. The parallel processor 118 includes circuitry to implement one or more processor cores 120-1 . . . N that each operate as a compute unit configured to perform one or more operations based on one or more instructions received by the parallel processor 118. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results. In the illustrated embodiment, the parallel processor 118 also includes one or more caches 122 that are used to cache frequently used instructions or data, which can be retrieved or fetched from the memory 106. For example, instructions can be fetched from the program code 108 and stored in an instruction cache in the caches 122; data can be fetched from the data 110 and stored in a data cache in the caches 122. Although the caches 122 are shown external to the processor cores 120, some embodiments of the processor cores 120 include additional, internal caches.

In the illustrated embodiment, the parallel processor 118 is configured to implement a partial visual attention mechanism that combines partial convolution with visual attention to achieve a better balance between speed and accuracy, relative to either partial convolution or visual attention implemented separately. The parallel processor 118 is configured to access a feature map that includes one or more channels of numerical values representing encoded data. For example, the feature map can be constructed from one or more vector embeddings that encode features of digital images, videos, or other visual inputs. The feature map for an image can be represented as values of pixels (indicated by height and width values) in a set of channels such as the red, green, and blue channels of a color image. The parallel processor 118 can generate first data by applying partial convolution to a first subset of the channels of the feature map and generate second data by applying a visual attention transformer to a second subset of the channels. The second subset is different than the first subset, e.g., the first and second subsets can include mutually exclusive subsets of the channels. In some embodiments, the parallel processor 118 performs partial convolution and visual attention concurrently on the first and second subsets. The parallel processor 118 then combines the first data and the second data to form information representing one or more features in the feature map. For example, the parallel processor 118 can perform computer vision tasks such as feature classification, image classification, object detection, object tracking, and content-based image retrieval.

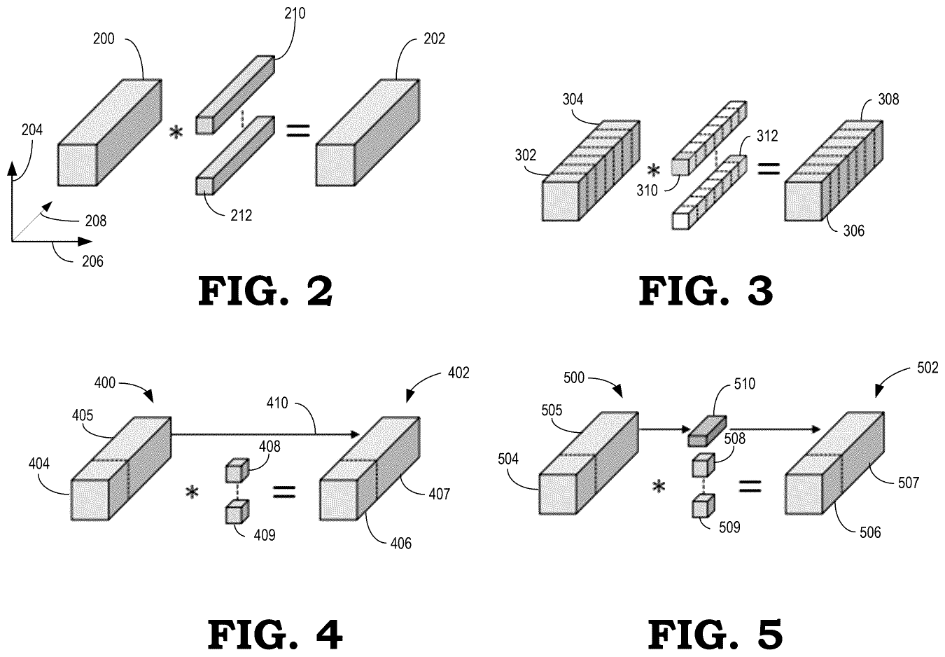

FIG. 2 illustrates applying convolution to a set of input channels 200 to generate a corresponding set of output channels 202. The input channels 200 can represent channels of an image, in which case the vertical dimension 204 and horizontal dimension 206 (in the plane of FIG. 2) of the input channels 200 represent height and width of the image and the channel dimension 208 extends into the plane of FIG. 2. Convolution kernels 210, 212 are defined for the channels along the channel dimension 208. Although only two convolution kernels 210, 212 corresponding to two channels are shown in FIG. 2, some embodiments of the set of input channels 200 include additional channels and corresponding kernels. The convolution operator (*) indicates that the input channels 200 are convolved with the convolution kernels 210, 212 to produce the output channels 202. Examples of convolution operators include a 1×1 convolution kernel, a 3×3 convolution kernel, and the like.

FIG. 3 illustrates applying depthwise convolution to a set of input channels to generate a corresponding set of output channels. The input channels include channels 302, 304 and only these channels are indicated by reference numerals in the interest of clarity. The output channels include channels 306, 308 and only these channels are indicated by reference numerals in the interest of clarity. To perform depthwise convolution, different kernels are mapped to corresponding input and output channels. In the illustrated embodiment, the convolution kernel 310 is applied to the input channel 302 to form the output channel 306. The convolution kernel 312 is applied to the input channel 304 to form the output channel 308.

FIG. 4 illustrates applying partial convolution to a set of input channels 400 to generate a corresponding set of output channels 402. The input channels 400 are partitioned, divided, separated, subdivided, or split into a first subset 404 and a second subset 405. The output channels 402 are partitioned, divided, separated, subdivided, or split into a first subset 406 and a second subset 407. Convolution kernels 408, 409 are applied to the first subset 404 of the input channels 400 to generate the first subset 406 of the output channels 402. An identity operation (indicated by the arrow 410) is applied to the second subset 405 of the input channels 400 to generate the second subset 407 of the output channels 402.

FIG. 5 illustrates applying partial convolution with attention to a set of input channels 500 to generate a corresponding set of output channels 502, according to some embodiments. The input channels 500 are partitioned, divided, separated, subdivided, or split into a first subset 504 and a second subset 505. The output channels 502 are partitioned, divided, separated, subdivided, or split into a first subset 506 and a second subset 507. Convolution kernels 508, 509 are applied to the first subset 504 of the input channels 500 to generate the first subset 506 of the output channels 502. An attention operation (indicated by the box 510) is applied to the second subset 505 of the input channels 500 to generate the second subset 507 of the output channels 502. Although the embodiment shown in FIG. 5 illustrates the first subset 504 and the second subset 505 being mapped to the first subset 506 and the second subset 507 via the convolution kernels 508, 509 and the attention operation 510, respectively, some embodiments combine information produced by the convolution kernels 508, 509, and the attention operation 510 and generate the output channels 502.

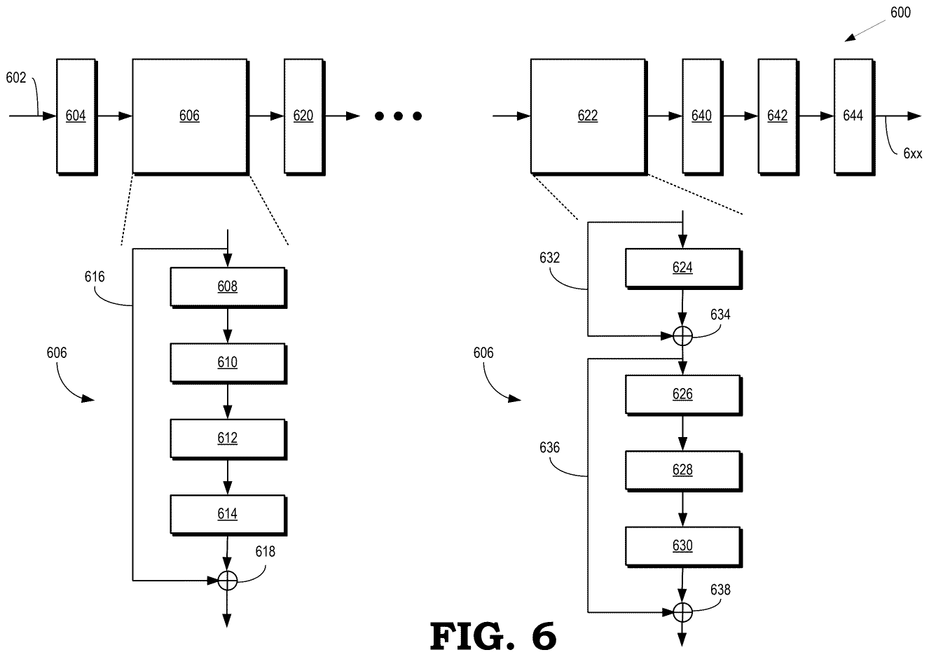

FIG. 6 illustrates a neural network system 600 that performs partial convolution on a first subset of channels and visual attention to a second subset of the channels, according to some embodiments. The neural network system 600 is implemented in some embodiments of the parallel processor 118 shown in FIG. 1. In the illustrated embodiment, the neural network system 600 receives input tensors 602 such as a tensor that represents one or more images such as digital images, videos, or other visual inputs. The input tensor 602 includes values along dimensions including height and width of the image and one or more channel dimensions such as the red, green, and blue channels of a color image.

An embedding block 604 receives the input tensor 602 and generates a feature map such as one or more vector embeddings that encode features of the data in a series (or vector) of numerical values that represent pixels in the image. In the illustrated embodiment, the embedding block 604 includes an embedding layer that applies a convolution, such as a 4×4 convolution with stride 4, to perform spatial downsampling, channel number expansion, or a combination thereof. For example, the feature map or tensor generated by the embedding block 604 can have dimensions of

$${c}_{1} \times \frac{h}{4} \times \frac{w}{4} ,$$

where c represents the number of channel dimensions, h represents the number of pixels along the height dimension of the original image, and w represents the number of pixels along the width dimension of the regional image. The number of layers implemented in the embedding block 604 is l₁.

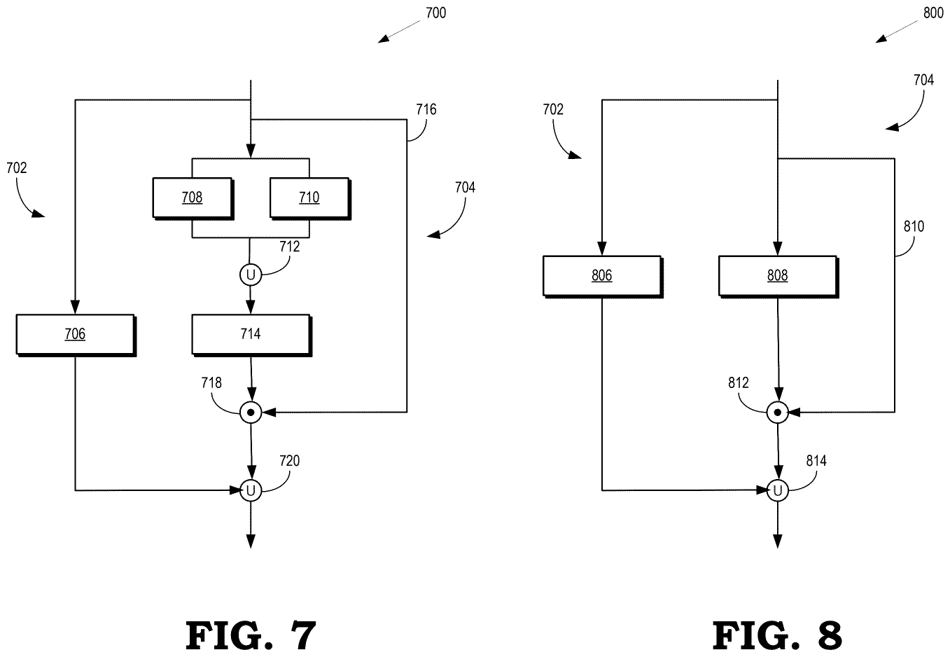

A partial visual attention (PAT) block 606 receives or accesses the data generated by the embedding block 604 and applies the PAT mechanism to the received data. In the illustrated embodiment, the PAT block 606 includes circuitry that implements a channel attention block 608, convolution blocks 610, 612 that perform reinforcement learning based on 1×1 convolutions, and a spatial attention block 614. A shortcut 616 is also provided for portions of the received data and data that traverses the shortcut 616 is combined with the processed data at the addition operator 618 to produce output data such as an output tensor. Implementations of the channel attention block 608 and the spatial attention block 614 are described with respect to FIGS. 7-10. The PAT block 606 provides the output tensor to a merging block 620 that includes circuitry that applies a convolution, such as a 4×4 convolution with stride 4, to perform spatial downsampling, channel number expansion, or a combination thereof. For example, the granularity of a tensor generated by the merging block 620 can be reduced so that the tensor has dimensions of

$${c}_{2} \times \frac{h}{8} \times \frac{w}{8} .$$

Although a single PAT block 606 and corresponding merging block 620 are shown in FIG. 6, some embodiments of the neural network system 600 include a set of hierarchical PAT blocks and corresponding merging blocks connected in series. For example, the neural network system 600 can include two additional PAT blocks and corresponding merging blocks. The first additional PAT block can operate on tensors that have dimensions of

$${c}_{2} \times \frac{h}{8} \times \frac{w}{8}$$

and provide data to a first merging block that reduces the granularity of the tensors so that the tensors have dimensions of

$${c}_{3} \times \frac{h}{16} \times \frac{w}{16} .$$

The second additional PAT block can operate on tensors that have dimensions of

$${c}_{3} \times \frac{h}{16} \times \frac{w}{16}$$

and provide data to a second merging block that reduces the granularity of the tensors so that the tensors that have dimensions of

$${c}_{4} \times \frac{h}{32} \times \frac{w}{32} .$$

Data such as tensors generated by the hierarchical set of PAT blocks and merging blocks are provided to the PAT block 622.

In the illustrated embodiment, the PAT block 622 differs from the PAT block 606 by implementing a different combination of attention mechanisms. In the illustrated embodiment, the PAT block 622 includes circuitry that implements a self-attention block 624, convolution blocks 626, 628 that perform reinforcement learning based on 1×1 convolutions, and a spatial attention block 630. A shortcut 632 is provided to allow portions of the received data to bypass the self-attention block 624. The data that traverses the shortcut 632 is combined with the processed data at the addition operator 634. Another shortcut 636 is provided to allow portions of the data to bypass the convolution blocks 626, 628 and the spatial attention block 630. The data that traverses the shortcut 636 is combined with the processed data at the addition operator 638. Implementations of the self-attention block 624 and the spatial attention block 614 are described with respect to FIGS. 7-10.

Feature classification circuitry receives data such as a tensor generated by the PAT block 622 and uses this information to classify one or more features in the received images. Although the illustrated embodiment depicts feature classification circuitry, some embodiments of the neural network system 600 can perform other computer vision tasks such as image classification, object detection, object tracking, and content-based image retrieval. The feature classification circuitry includes one or more pooling layers 640 to pool information in the received data, a convolution layer 642 such as a 1×1 convolution layer, and a feature classification layer 644 that includes circuitry for classifying features based on the information received from the convolution layer 642. The feature classification layer 644 generates output 646 that indicates classifications of one or more features performed by the neural network system 600.

The number of layers in the PAT blocks can be adjusted to improve network accuracy while having minimal impact on inference speed in the neural network system 600. In some embodiments, the depth of the PAT block 622 is double the depths of the PAT block 606 and, if present, another PAT block deployed between the PAT block 606 and the PAT block 622. In some embodiments, normalization or activation layers are implemented after some convolution blocks to preserve feature diversity. Batch normalization can be performed in adjacent convolution layers to expedite inference without sacrificing performance.

The information generated by blocks that implement the partial visual attention mechanism can be formulated in terms of the input and output tensors. The input and output to a block that implements the partial visual attention mechanism can be represented as:

$$X , Y ∈ {ℝ}^{H \times W \times C}$$

Where C, H, and W represent the number of channels, height, and width of the channel, respectively. In this formulation, the number of channels remains unchanged after applying partial visual attention. The output and then be represented as:

$$Y = {Y}^{{C}_{p}} ⋃ {Y}^{C - {C}_{p}} = Conv ( {X}^{{C}_{p}} ) ⋃ Atten ( {X}^{C - {C}_{p}} )$$

Where ∪ presents the union or concatenation operation, Conv denotes regular convolution, and Atten denotes the attention function, which can be channel attention, spatial attention, self-attention, or other attention mechanism. The channels are partitioned or split according to a hyperparameter rₚ that represents a ratio used to select a portion of the channels so that Cₚ=rₚ×C.

FIG. 7 illustrates a partial visual attention (PAT) block 700 that implements channel attention, according to some embodiments. The PAT block 700 is used to implement some embodiments of the channel attention block 608 shown in FIG. 6. In the illustrated embodiment, the PAT block 700 receives an input tensor (X) having dimensions H×W×C and the input tensor is split into two tensors that include first and second subsets of the channels so that the two tensors have the dimensions H×W×Cₚ and H×W×C_{p′}, respectively, where C=Cₚ+C_{p′}. The first tensor that includes the first subset of the channels is processed along a first branch 702 and the second tensor that that includes the second subset of the channels is processed along a second branch 704.

The first branch 702 includes circuitry configured to perform partial convolution on the first subset Cₚ of the channels. In the illustrated embodiment, the first branch 702 includes a convolution block 706. For example, the convolution block 706 can implement a 3×3 convolution operation on the tensor that represents the first subset. The second branch 704 includes blocks 708, 710 that perform standard deviation and mean operations, respectively, on the received data. The statistical information is then concatenated at the concatenation operation 712 and the results are provided to convolution block 714. For example, the convolution block 714 can perform a 1×2 convolution operation on the received statistical information. A Hard-Sigmoid operation is performed on the data produced by the convolution block 714. The second branch 704 also includes a shortcut 716 that allows a copy of the second subset to bypass the statistical operations and then be merged with the statistical information at the dot product operator 718. Data produced by the first branch 702 and the second branch 704 are concatenated at the concatenation operation 720.

FIG. 8 illustrates a PAT block 800 that implements spatial attention, according to some embodiments. The PAT block 800 is used to implement some embodiments of the spatial attention block 614 shown in FIG. 6. In the illustrated embodiment, the PAT block 800 receives an input tensor (X) having dimensions H×W×C and the input tensor is split into two tensors that include first and second subsets of the channels so that the two tensors have the dimensions H×W×Cₚ and H×W×C_{p′}, respectively, where C=Cₚ+C_{p′}. The first tensor that includes the first subset of the channels is processed along a first branch 802 and the second tensor that that includes the second subset of the channels is processed along a second branch 804.

The first branch 802 includes circuitry configured to perform partial convolution on the first subset Cy of the channels. In the illustrated embodiment, the first branch 802 includes a convolution block 806. For example, the convolution block 806 can implement a 1×1 convolution operation for the tensor that represents the first subset. The second branch 804 can perform spatial attention by applying a convolution block 808. For example, the convolution block 808 can implement a 1×1 convolution operation on the tensor that represents the second subset. A Hard-Sigmoid operation is performed on the data produced by the convolution block 808. In the illustrated embodiment, the spatial attention mechanism implemented in the second branch 804 employs a point-wise convolution to squeeze global channel information into tensor with only a single channel. After passing through the Hard-Sigmoid activation, this tensor serves as the spatial attention map to weight features. The second branch 804 also includes a shortcut 810 that allows a copy of the second subset to bypass the convolution block 808 and then be merged with the information generated by the convolution block 808 at the dot product operator 812. Data produced by the first branch 802 and the second branch 804 are concatenated at the concatenation operation 814.

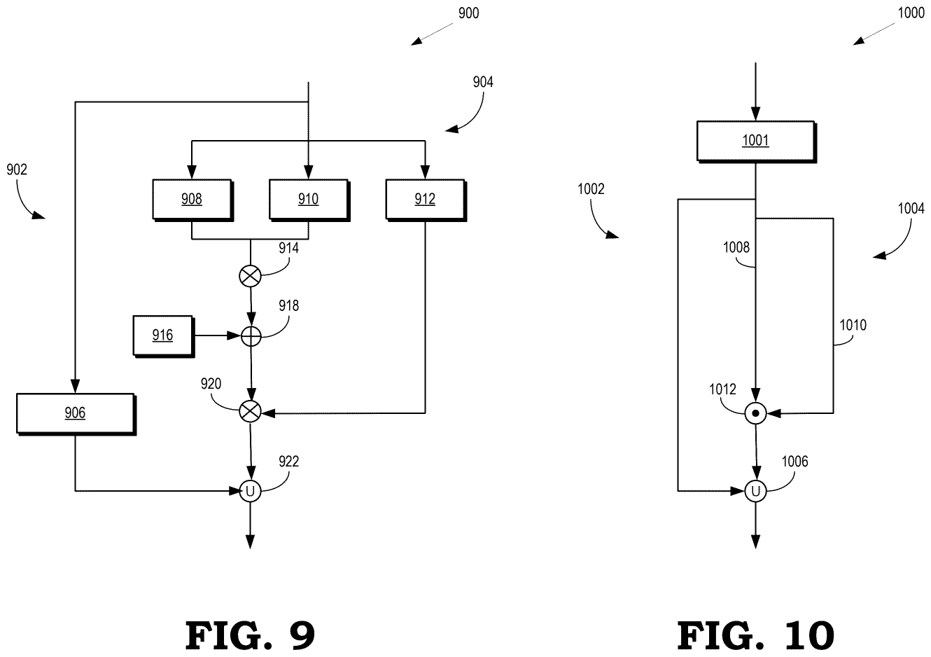

FIG. 9 illustrates a PAT block 900 that implements self-attention, according to some embodiments. The PAT block 900 is used to implement some embodiments of the self-attention block 624 shown in FIG. 6. In the illustrated embodiment, the PAT block 900 receives an input tensor (X) having dimensions H×W×C and the input tensor is split into two tensors that include first and second subsets of the channels so that the two tensors have the dimensions H×W×Cₚ and H×W×C_{p′}, respectively, where C=Cₚ+C_{p′}. The first tensor that includes the first subset of the channels is processed along a first branch 902 and the second tensor that that includes the second subset of the channels is processed along a second branch 904.

In the illustrated embodiment, the first branch 902 includes a convolution block 906. For example, the convolution block 806 can implement a 1×1 convolution operation on the tensor that represents the first subset. The second branch 904 implements self-attention using circuitry that includes a set of convolution blocks 908, 910, 912. For example, the convolution block 908 can implement a 1×1 convolution operation on the tensor that represents the second subset to form a Query, the convolution block 910 can implement a 1×1 convolution operation to form a Key, and the convolution block 912 can implement a 1×1 convolution operation to form a Value. The Query produced by the convolution block 908 is combined with the Key produced by the convolution block 910 at the multiplication operation 914. Relative position encoding (RPE, indicated by the block 916) is incorporated by combining with the output of the multiplication operation 914 at the addition operation 918. A softmax operation is performed on the data produced by the addition operation 918 and the result is combined with the Value generated by the convolution block 912 at the multiplication operation 920. Data produced by the first branch 902 and the second branch 904 are concatenated at the concatenation operation 922.

FIG. 10 illustrates a PAT block 1000 that implements fused spatial attention, according to some embodiments. The PAT block 1000 is used to implement some embodiments of the spatial attention block 614 shown in FIG. 6. In the illustrated embodiment, the PAT block 1000 receives an input tensor (X) having dimensions H×W×C and the input tensor is provided to a fused convolution block 1001. For example, the fused convolution block 1001 can be implemented as a fused 1×1 convolution operation. A data generated by the fused convolution block 1001 is split into two tensors that include first and second subsets of the channels so that the two tensors have the dimensions H×W×Cₚ and H×W×C_{p′}, respectively, where C=Cₚ+C_{p′}. The first tensor that includes the first subset of the channels is processed along a first branch 1002 and the second tensor that that includes the second subset of the channels is processed along a second branch 1004.

In the illustrated embodiment, the first branch 1002 passes the first subset to the concatenation operation 1006. The second branch 1004 is divided into two portions 1008, 1010 that operate on first and second portions of the second subset, respectively. The first portion of the second subset has dimensions H×W×1 and a Hard-Sigmoid function is applied to the first portion along the portion 1008 of the second branch 1004. The second portion of the second subset has dimensions H×W×C_{p′} and the second portion bypasses the Hard-Sigmoid function along the portion 1010 of the second branch 1004. The first and second portions of the second subset are then combined using the dot product operator 1012 and the combined data is concatenated with data generated along the first branch 1002 at the concatenation operation 1006.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a processing unit comprising one or more processor cores configured to:
access a feature map comprising a plurality of channels of numerical values representing encoded data;
generate first data by applying partial convolution to a first subset of the plurality of channels;
generate second data by applying a visual attention transformer to a second subset of the plurality of channels, wherein the second subset is different than the first subset; and
combine the first data and the second data to form information representing at least one feature in the feature map.

2. The apparatus of claim 1, wherein the feature map comprises a tensor representing values of pixels for the plurality of channels, wherein the values of the pixels are indicated by a height and a width within an image represented by the pixels, and wherein the processing unit is configured to identify or classify the at least one feature in the feature map associated with an image represented by the pixels.

3. The apparatus of claim 1, wherein the processing unit is configured to implement a visual attention block that applies the visual attention transformer to perform at least one of channel attention, spatial attention, or self-attention on the second subset.

4. The apparatus of claim 3, wherein the processing unit is configured to perform channel attention on the second subset concurrently with applying a convolution kernel to the first subset.

5. The apparatus of claim 4, wherein the processing unit is configured to apply a dense convolution and a Hard-Sigmoid function to obtain attention weights for the second subset.

6. The apparatus of claim 3, wherein the processing unit is configured to perform spatial attention by applying a point-wise convolution to the second subset concurrently with applying a convolution kernel to the first subset.

7. The apparatus of claim 6, wherein the processing unit is configured to convert global channel information into a tensor having a single channel, wherein the tensor represents a spatial attention map that weights features in the second subset.

8. The apparatus of claim 6, wherein the processing unit is configured to perform spatial attention by applying convolution kernels to determine query, key, and value tensors associated with the second subset.

9. A method comprising:
accessing a feature map comprising a tensor of numerical values representing pixels for a plurality of channels, wherein the pixels are indicated by a height and a width within an image represented by the pixels;
generating first data by applying partial convolution to a first subset of the plurality of channels;
generating second data by applying a visual attention transformer to a second subset of the plurality of channels, wherein the second subset is different than the first subset; and
combining the first data and the second data to form a model representing at least one feature in the image.

10. The method of claim 9, wherein generating the second data comprises performing at least one of channel attention, spatial attention, or self-attention on the second subset.

11. The method of claim 9, wherein generating the second data comprises performing channel attention on the second subset concurrently with generating the first data by applying a convolution kernel to the first subset.

12. The method of claim 11, wherein generating the second data comprises applying a dense convolution and a Hard-Sigmoid function to obtain attention weights for the second subset.

13. The method of claim 10, wherein generating the second data comprises performing spatial attention by applying a point-wise convolution to the second subset concurrently with applying a convolution kernel to the first subset to generate the first data.

14. The method of claim 13, wherein generating the second data comprises converting global channel information into a tensor having a single channel, wherein the tensor represents a spatial attention map that weights features in the second subset.

15. The method of claim 13, wherein performing spatial attention comprises applying convolution kernels to determine query, key, and value tensors associated with the second subset.

16. A neural network system to perform feature classification on images, the neural network system comprising:
at least one partial convolution circuit configured to access an input tensor of numerical values that represent pixels indicated by height, width, and channel of at least one image, split the input tensor into a first tensor that represents a first subset of channels of the at least one image and a second tensor that represents a second subset of the channels of the at least one image, apply convolution operators to the first subset along a first branch and visual attention to the second subset along a second branch, and concatenate output from the first branch and the second branch to form an output tensor; and
feature classification circuitry configured to convert the output tensor to information representing at least one feature in the at least one image.

17. The neural network system of claim 16, wherein the at least one partial convolution circuit comprises:
at least one first hierarchical block comprising a first partial convolution circuit configured to receive the input tensor and generate a first output tensor by applying the convolution operators to the first subset of the input tensor and visual attention to the second subset;
at least one first merging circuit configured to reduce granularity of the height and the width of the first output tensor to form a second input tensor; and
a second hierarchical block comprising a second partial convolution circuit configured to receive the second input tensor and generate a second output tensor by applying the convolution operators to a first subset of the second input tensor and visual attention to a second subset of the second input tensor.

18. The neural network system of claim 17, wherein the at least one first hierarchical block comprises channel attention circuitry configured to apply convolution operations to a subset of channels of the input tensor and spatial attention circuitry configured to apply a point-wise convolution to convert global channel information into a spatial tensor having a single channel.

19. The neural network system of claim 17, wherein the second hierarchical block comprises self-attention circuitry configured to apply convolution operations to compute tensors representing a query, a key, and a value, and spatial attention circuitry configured to apply a point-wise convolution to convert global channel information into a spatial tensor having a single channel.

20. The neural network system of claim 17, further comprising:
embedding circuitry configured to encode at least one image as the input tensor, wherein the input tensor comprises numerical values that represent pixels indicated by height, width, and channel; and
wherein the feature classification circuitry comprises at least one of a pooling layer, a convolution layer, and a feature classification layer.
